(19) United States
(12) Patent Application Publication
(10) Pub. No.: US 2009/0294202 A1
(43) Pub. Date: Dec. 3, 2009

(54) NOISE REDUCTION DEVICE OF MOTOR DRIVEN POWER STEERING SYSTEM

(75) Inventors: Changmoo CHOI, Seongnam-si (KR); Kyungbok LEE, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seocho-ku (KR)

(21) Appl. No.: 12/339,634

(22) Filed: Dec. 19, 2008

(30) Foreign Application Priority Data
May 27, 2008 (KR) 10-2008-0049178
Oct. 21, 2008 (KR) 10-2008-0103232

(51) Int. Cl. F16F 15/12; B62D 5/00

(52) U.S. Cl. 180/425; 280/124.108

(57) ABSTRACT

A noise reduction device of a motor driven power steering system may include a worm gear shaft, one end of which is connected with a tilt bearing that is coupled to a housing and rotatably supports the worm gear shaft, a driving shaft connected to a motor, a power transmission member integrally fitted with the driving shaft of the motor, a coupling connected to one end of the driving shaft of the motor and integrally coupling the driving shaft of the motor to the worm gear shaft to be rotatable therebetween, wherein the coupling includes a coupling body, and an elastic cushion member formed on one or both lateral surfaces of the coupling to buffer vibration and/or noise.

### CROSS-REFERENCE TO RELATED APPLICATIONS

The present application claims priority to Korean Patent Application Numbers 10-2008-0049178 and 10-2008-0103232, filed May 27, 2008 and Oct. 21, 2008 respectively, the entire contents of which applications are incorporated herein for all purposes by this reference.

### BACKGROUND OF THE INVENTION

1. Field of the Invention

The present invention relates to a motor driven power steering system, and more particularly, to a noise reduction device of a motor driven power steering system that is capable of effectively reducing operation noise generated in a bearing in controlling steering a steering wheel by supporting an inner ring of the bearing for rotatably supporting a worm gear shaft on an elastic body.

2. Description of Related Art

A power steering system assisting the driver's control force of a steering wheel has been widely known as a steering system for a vehicle and a hydraulic power steering system assisting the driver's control force of the steering wheel by generating oil pressure has been generally used in the power steering system. However, recently, an environmental-friendly motor driven power steering system that assists the driver's control force of the steering wheel by the rotation force of a motor has been used as the power steering system.

The motor driven power steering system achieves driving stability by increasing steering assistance force to make the control force of the steering wheel lighter in driving the vehicle at low speed while decreasing the steering assistance force to make the control force of the steering wheel heavier, and provides a driver to optimal steering assistance force by enabling rapid steering in emergency.

The motor driven power steering system is classified into various types in accordance with an installation position of the motor. FIG. 1 illustrates an example of a column type motor driven power steering system in which a motor is installed on a steering column.

That is, a worm wheel gear 2 is integrally mounted on the periphery of a steering column 1 connected to a steering wheel to be rotatable. A worm gear 3 engaged with worm wheel gear 2 is formed on a worm gear shaft 3a. Worm gear shaft 3a is supported on bearings 4a and 4b at both ends thereof. Worm gear shaft 3a is connected to a motor 5 via a coupling 6 to be transmitted with rotation force from motor 5.

Worm gear 3 and worm wheel gear 2 constitute a reduction gear that reduces the rotation speed of driving motor 5 to transmit the reduced rotation speed to steering column 1.

A clearance is formed between teeth of worm gear 3 and worm wheel gear 2 due to generation of abrasion as sustenance is progressed. One side of worm gear 3 is supported on an elastic body such as a plate spring 3b to allow the teeth of worm gear 3 and worm wheel gear 2 are always engaged with each other by preventing the clearance and one bearing 4a is composed of a tilt bearing 4a to allow worm gear shaft 3a to tilt toward worm wheel gear 2.

FIG. 2 is a cross-sectional view illustrating a connection state of motor 5 and worm gear shaft 3a. That is, a power transmission member 7 is integrally fitted with a driving shaft 5a of motor 5 via a spline to be rotatable, power transmission member 7 is connected to worm gear shaft 3a via coupling 6 to allow the rotation force of motor 5 to be transmitted to worm gear shaft 3a through driving shaft 5a of motor 5, power transmission member 7, and coupling 6, a bush 8 is inserted in worm gear shaft 3a, and a spring 9 elastically supporting worm gear shaft 3a and driving shaft 5a of motor 5 is fitted in the outer periphery of bush 8.

FIG. 3 is a front view of coupling 6. Coupling 6 includes a coupling body 6a having an assembly hole in the center thereof to be inserted in driving shaft 5a of motor 5, and eight arms 6b that extends and projects in a radial direction while being arranged at a regular interval on the outer periphery of coupling body 6a in a circumferential direction, wherein eight coupling holes 6c are formed between arms 6b and projections projected from power transmission member 7, and projections projected from worm gear shaft 5a are alternately inserted in eight coupling holes 6c, such that power transmission member 7 is connected to worm gear shaft 3a via coupling 6.

Coupling 6 is generally made of an elastic body such as rubber. As a result, coupling 6 absorbs and reduces a rapid change in torque of motor 5 and alleviates a shock at the time of transmitting rotation force of motor 5 to worm gear shaft 3a.

FIG. 4 is an enlarged cross-sectional view illustrating an arrangement relationship between coupling 6 and tilt bearing 4a. That is, tilt bearing 4a includes an outer ring 4aa that is fixedly mounted on a housing, an inner ring 4ab that is press-fitted in the outer periphery of worm gear shaft 3a, and a plurality of balls 4ac that are interposed between outer ring 4aa and inner ring 4ab, wherein receiving grooves 4ad receiving balls 4ac are formed on surfaces of outer ring 4aa and inner ring 4ab opposed to each other, diameters of receiving grooves 4ad are larger than those of balls 4ac, such that balls 4ac can move in upper, lower, left and right directions in a state that balls 4ac are received in receiving grooves 4ad.

Accordingly, worm gear shaft 3a that is fitted and supported by tilt bearing 4a can move in an axial direction thereof by receiving grooves of tilt bearing 4a and can tilt to worm wheel gear 2.

Coupling 6 can perform only a function of transmitting the rotation force of motor 5 between motor 5 and worm gear 3, but coupling 6 cannot play any role to support worm gear 3 in the axial direction.

However, in a structure in which worm gear shaft 3a is supported via the above-described tilt bearing 4a, worm gear shaft 3a moves left and right at the time of releasing worm gear shaft 3a after steering worm gear shaft 3a left and right in stopping the vehicle and driving the vehicle on a rough road. In this case, balls 4ac of tilt bearing 4a supporting worm gear shaft 3a also moves left and right with being interposed between inner ring 4ab and outer ring 4aa due to left and right movement of worm gear shaft 3a, thereby generating operation noise.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a noise reduction device of a motor driven power steering system that is capable of improving ride comfort and steering operation feel of a vehicle by reducing operation noise generated in a tilt bearing at the time of controlling a steering wheel by elastically supporting left and right movement of the tilt bearing that rotatably supports a worm gear shaft.

In an aspect of the present invention, a noise reduction device of a motor driven power steering system, may include a worm gear shaft, one end of which is connected with a tilt bearing that is coupled to a housing and rotatably supports the worm gear shaft, a driving shaft connected to a motor, a power transmission member integrally fitted with the driving shaft of the motor, a coupling connected to one end of the driving shaft of the motor and integrally coupling the driving shaft of the motor to the worm gear shaft to be rotatable therebetween, wherein the coupling includes a coupling body, and an elastic cushion member formed on one or both lateral surfaces of the coupling to buffer vibration and/or noise.

The coupling may include a plurality of arms that project in a radial direction from outer periphery of the coupling body with a predetermined interval in a circumferential direction thereof.

The noise reduction device may further include an elastic actuating member that is disposed between the motor and the coupling, and elastically actuating the coupling toward the worm gear shaft. The elastic actuating member may be mounted on the driving shaft of the motor.

The elastic actuating member may include a stopper fastened to a stationary member and slidably receiving the driving shaft of the motor, a spring seat formed on the coupling, and an elastic member interposed between the stopper and the spring seat to bias the spring seat toward the worm gear shaft. The elastic member may be a coil spring.

The elastic cushion member may be interposed between the worm gear shaft and the coupling. The elastic cushion member may elastically support an inner ring of the tilt bearing or a front end of the worm gear shaft. The elastic cushion member may include a plurality of elastic projections formed on arms of the coupling, a plurality of arms being configured to project in a radial direction from outer periphery of the coupling body with a predetermined interval in a circumferential direction thereof. The elastic cushion member may be a plate spring that is mounted on the coupling body and bent toward the worm gear shaft. The elastic cushion member may be a plurality of leaf springs that are mounted on the coupling body, arranged with a predetermined interval in a circumferential direction thereof, and bent toward the worm gear shaft.

The elastic cushion member facing the power transmission member elastically may support the power transmission member. The elastic cushion member may include a plurality of elastic projections formed on arms of the coupling, a plurality of arms being configured to project in a radial direction from outer periphery of the coupling body with a predetermined interval in a circumferential direction thereof. The elastic cushion member may be a plate spring that is mounted on the coupling body and bent toward the power transmission member. The elastic cushion member may be a plurality of leaf springs that are mounted on the coupling body, arranged with a predetermined interval in a circumferential direction thereof, and bent toward the power transmission member.

The elastic cushion members formed on both lateral surfaces of the coupling may be arranged to be left-right symmetric on the basis of the coupling.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cut perspective view of a known motor driven power steering system.

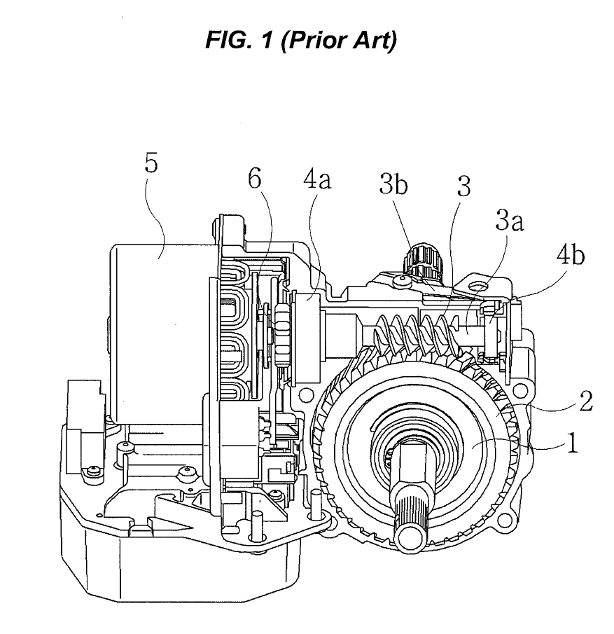

FIG. 2 is an enlarged cross-sectional view of a major part of FIG. 1.

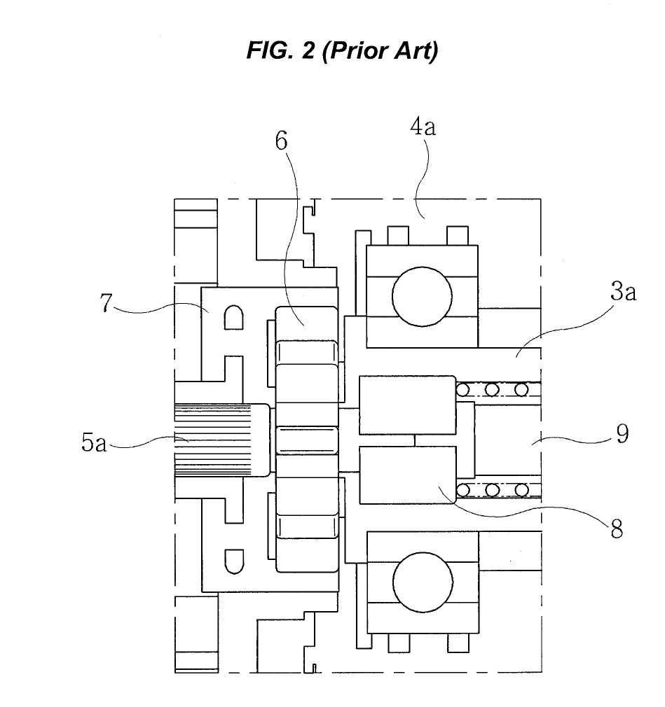

FIG. 3 is a front view of a coupling.

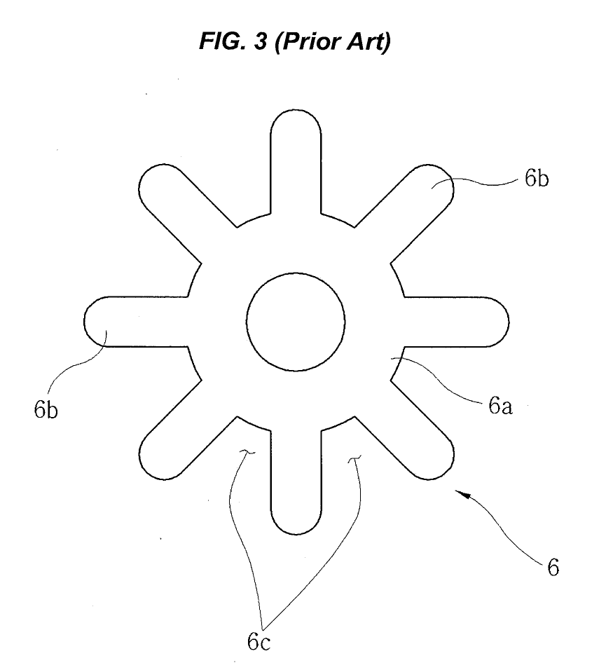

FIG. 4 is an enlarged cross-sectional view of a major part of FIG. 2.

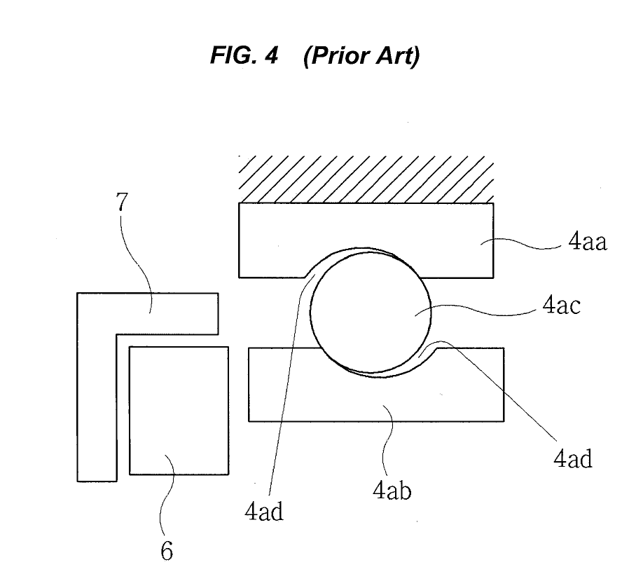

FIG. 5 is a front view of a major part of a motor driven power steering system with a noise reduction device illustrating a first exemplary embodiment of the invention.

FIG. 6 is a cross-sectional view of a major part of FIG. 5.

FIG. 7 is a plan view of a coupling illustrating a first exemplary embodiment of the present invention.

FIG. 8 is a front view of a major part of a motor driven power steering system with a noise reduction device illustrating a second exemplary embodiment of the invention.

FIG. 9 is a cross-sectional view of a major part of FIG. 8.

FIG. 10 is a front view of a major part of a motor driven power steering system with a noise reduction device illustrating a third exemplary embodiment of the invention.

FIG. 11 is a cross-sectional view of a major part of FIG. 10.

FIG. 12 is a perspective view of a major part of a motor driven power steering system with a noise reduction device illustrating a fourth exemplary embodiment of the invention.

FIG. 13 is a cross-sectional view of a major part of FIG. 12.

FIG. 14 is a front view of a major part of a motor driven power steering system with a noise reduction device illustrating a fifth exemplary embodiment of the invention.

FIG. 15 is a cross-sectional view of a major part of FIG. 14.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

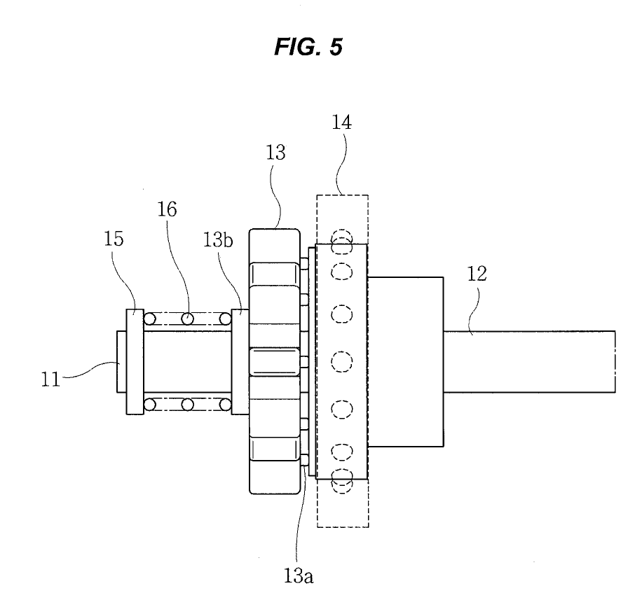

FIG. 5 is a front view of a major part of a motor driven power steering system with a noise reduction device illustrating a first exemplary embodiment of the invention. That is, a coupling 13 is interposed between a driving shaft 11 of a motor and a worm gear shaft 12 to transmit the rotation force of driving shaft 11 of the motor to worm gear shaft 12, one end of worm gear shaft 12 that is opposed to driving shaft 11 is rotatably supported via a tilt bearing 14, and a plurality of elastic projections 13a integrally project on a surface of coupling 13 opposed to worm gear shaft 12 of coupling 13 toward worm gear shaft 12.

A stopper 15 may be connected to a stationary member, a spring seat 13b is formed on a lateral surface of coupling 13 opposed to stopper 15, and a coil spring 16 is inserted between stopper 15 and spring seat 13b as an elastic body, thereby elastically supporting coupling 13 while elastically pushing coupling 13 toward worm gear shaft 12. In an exemplary embodiment of the present invention, the stationary member may be a housing and the stopper 15 slidably receives the driving shaft 11 so that the spring seat 13b can move relatively from the stopper 15.

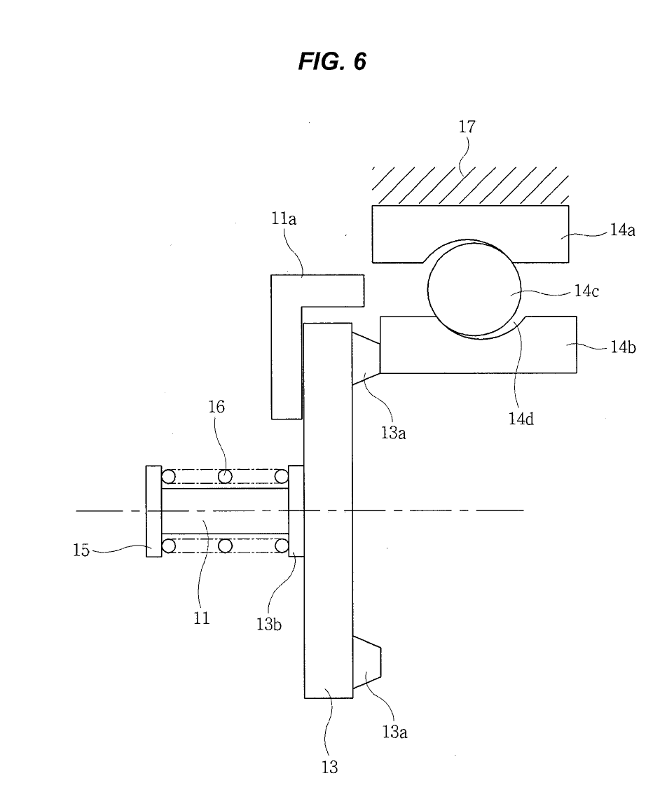

FIG. 6 is a cross-sectional view of a major part of FIG. 5. Tilt bearing 14 includes an outer ring 14a that is fixed to a housing 17, an inner ring 14b that is supported by being fitted in worm gear shaft 12, a plurality of balls 14c that are interposed between outer ring 14a and inner ring 14b, and receiving grooves 14d that are formed on inner surfaces of outer ring 14a and inner ring 14b, which are opposed to each other to have diameters larger than those of balls 14c to receive balls 14c.

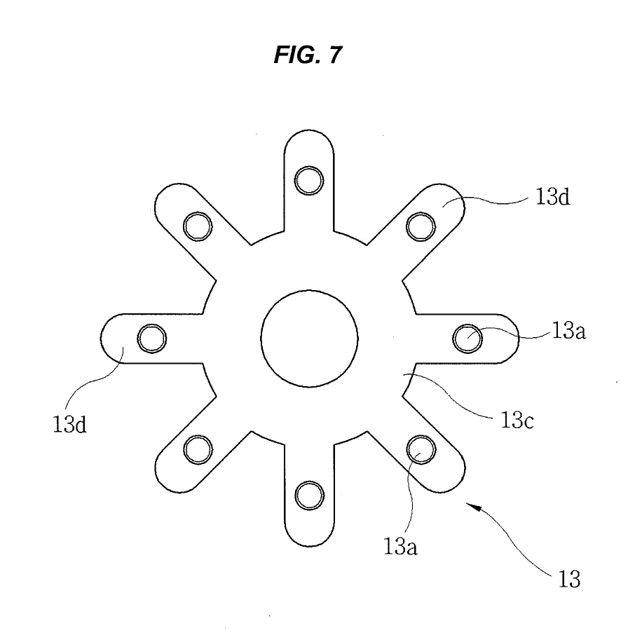

As shown in FIG. 7, coupling 13 includes a coupling body 13c that has an assembly hole in the center thereof to be fitted in driving shaft 11 of the motor and a plurality of arms 13d that project in a radial direction while being arranged on the outer periphery of coupling body 13c at a predetermined interval in a circumferential direction, wherein elastic projections 13a integrally project on each of arms 13d. Each elastic projection 13a is in close contact with inner ring 14b to elastically support inner ring 14b.

The coupling 13 may be made of a rubber material having proper elasticity.

A power transmission member 11a and worm gear shaft 12 that are integrally coupled to driving shaft 11 of the motor to be rotatable are coupled to coupling 13. Therefore, a process of transmitting the rotation force of the motor to worm gear shaft 12 through coupling 13 is the same as the known motor driven power steering system.

Accordingly, when inner ring 14b of tilt bearing 14 move in an axial direction while worm gear shaft 12 is pushed in the axial direction in accordance with operation of a steering wheel, coil spring 16 elastically supports tilt bearing 14 via coupling 13 and elastic projections 13a of coupling 13 also elastically support tilt bearing 14. Therefore, axial support strength of tilt bearing 14 increases and operation noise generated in tilt bearing 14 is reduced by properly absorbing a shock generated in tilt bearing 14.

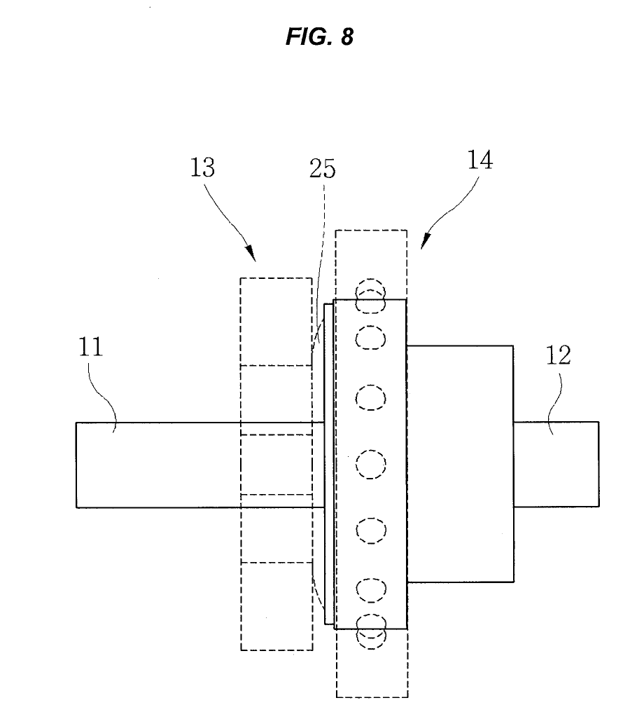

FIG. 8 is a front view of a major part of a motor driven power steering system with a noise reduction device illustrating a second exemplary embodiment of the invention. That is, coupling 13 is interposed between driving shaft 11 of the motor and worm gear shaft 12 to transmit the rotation force of driving shaft 11 of the motor to worm gear shaft 12, one end of worm gear shaft 12 that is opposed to driving shaft 11 is rotatably supported via tilt bearing 14, and a plurality of plate spring 25 gently bent to worm gear shaft 12 is integrally and fixedly attached onto a surface of coupling 13 opposed to worm gear shaft 12 of coupling 13 toward worm gear shaft 12.

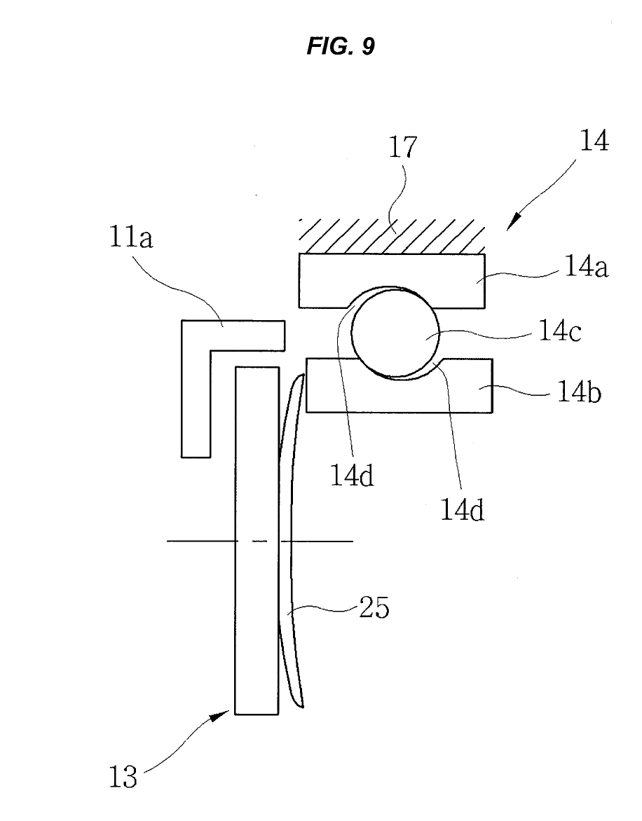

FIG. 9 is a cross-sectional view of a major part of FIG. 8. Tilt bearing 14 includes outer ring 14a that is fixed to a housing 17, inner ring 14b that is supported by being fitted in worm gear shaft 12, balls 14c that are interposed between outer ring 14a and inner ring 14b, and receiving grooves 14d that are formed on inner surfaces of outer ring 14a and inner ring 14b, which are opposed to each other to have diameters larger than those of balls 14c to receive balls 14c.

The outer periphery of plate spring 25 is in close contact directly with inner ring 14b of tilt bearing 14 or elastically supports inner ring 14b with worm gear shaft 12 interposed therebetween.

Accordingly, when tilt bearing 14 also moves in the axial direction while worm gear shaft 12 is pushed in the axial direction in accordance with the operation of the steering wheel, plate spring 25 elastically supports tilt bearing 14. Therefore, the axial supporting strength of tilt bearing 14 increases and the operation noise is reduced by plate spring 25's absorbing the shock generated in tilt bearing 14.

In another exemplary embodiment of the present invention, the exemplary embodiment as shown in FIGS. 5 and 6 may be applied to the present exemplary embodiment. For instance, a stopper 15 may be fitted with and fixedly mounted on the outer periphery of driving shaft 11, a spring seat 13b may be formed on a lateral surface of coupling 13 opposed to stopper 15, and a coil spring 16 may be inserted between stopper 15 and spring seat 13b as an elastic body, thereby elastically supporting coupling 13 while elastically pushing coupling 13 toward worm gear shaft 12 with the plate spring 25.

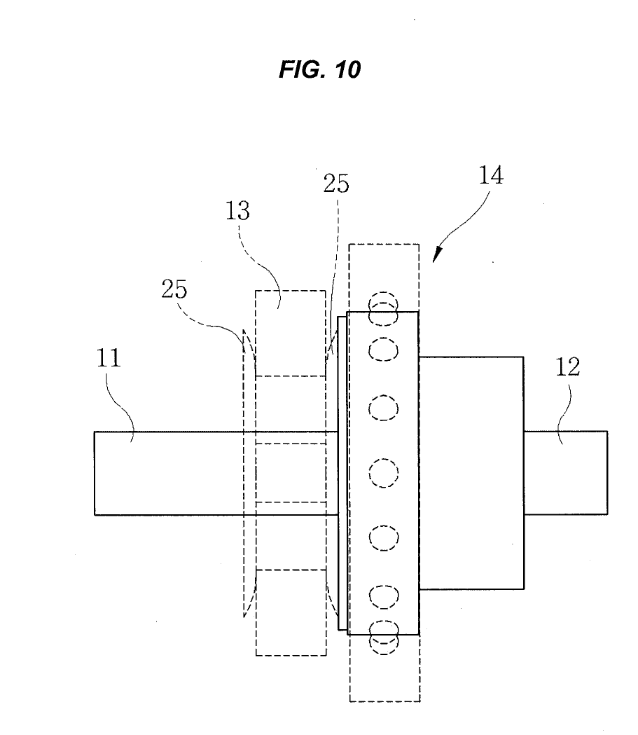

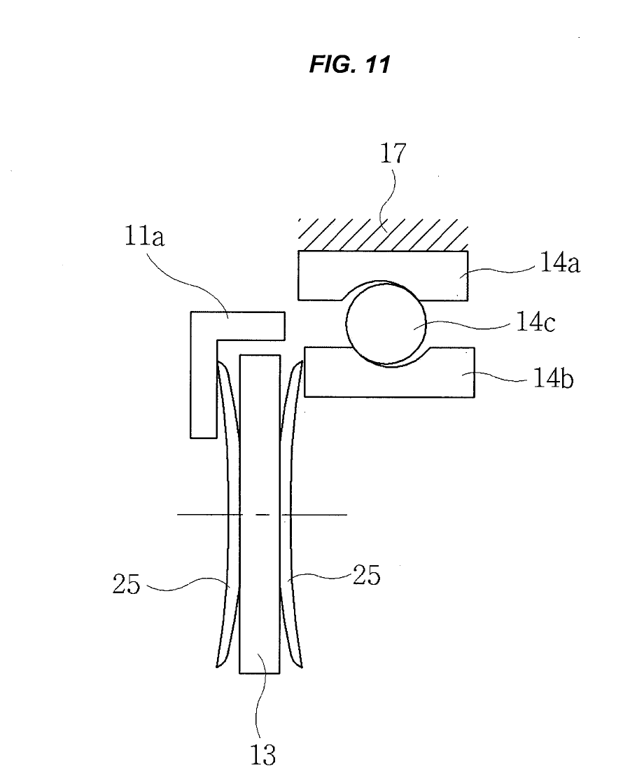

FIGS. 10 and 11 are a front view and a cross-sectional view of a major part of a motor driven power steering system with a noise reduction device illustrating a third exemplary embodiment of the present invention, respectively. In the third exemplary embodiment of the invention, plate spring 25 is attached onto each of one lateral surface of coupling body 13c opposed to the motor and the other lateral surface of coupling body 13c opposed to worm gear shaft 12, such that damping and shock-absorbing effects are better than those in the second exemplary embodiment, thereby improving a noise reduction effect.

That is, plate spring 25 is interposed between power transmission member 11a connecting driving shaft 11 to coupling 13 and the one surface of coupling 13 opposed to the motor.

In another exemplary embodiment of the present invention, the exemplary embodiment as shown in FIGS. 5 and 6 may be applied to the present exemplary embodiment. For instance, a stopper 15 may be fitted with and fixedly mounted on the outer periphery of driving shaft 11, a spring seat 13b may be formed on a lateral surface of coupling 13 opposed to stopper 15, and a coil spring 16 may be inserted between stopper 15 and spring seat 13b as an elastic body, thereby elastically supporting coupling 13 while elastically pushing coupling 13 toward worm gear shaft 12 with the plate springs 25.

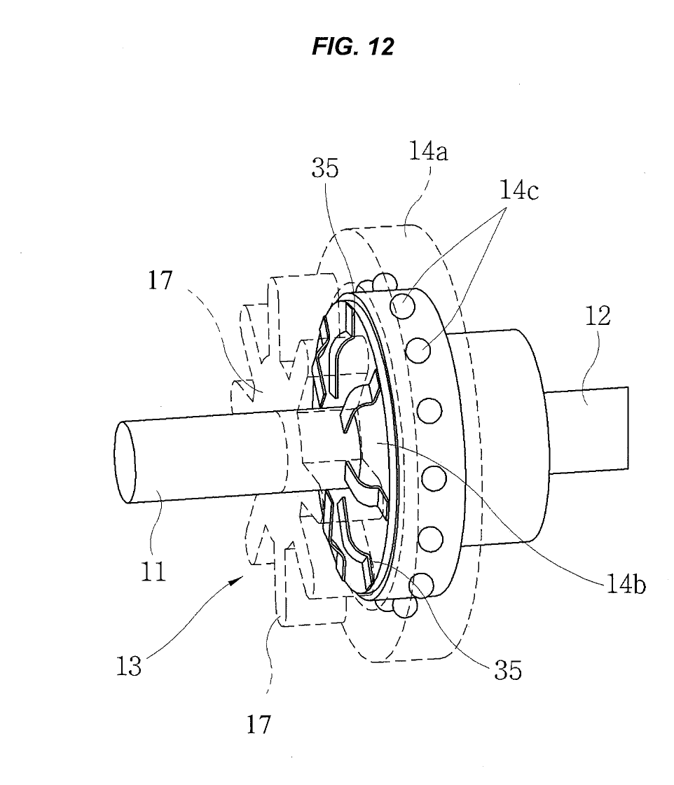

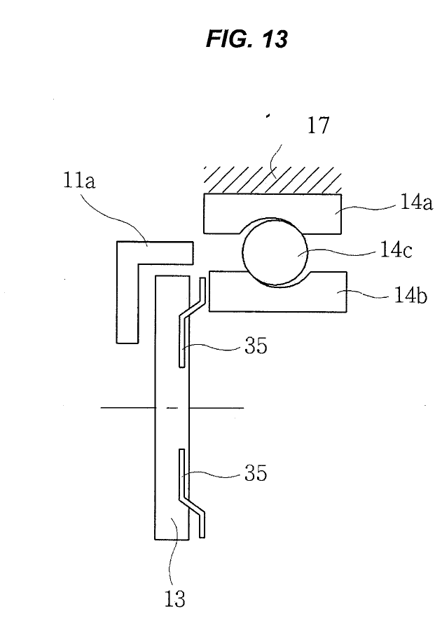

FIGS. 12 and 13 are a perspective view and a cross-sectional view of a major part of a motor driven power steering system with a noise reduction device illustrating a fourth exemplary embodiment of the present invention, respectively. The fourth exemplary embodiment of the invention is different from other exemplary embodiments in that a plurality of leaf springs 35 are used instead of plate spring 25 and the fourth exemplary embodiment is the same as other exemplary embodiments in that tilt bearing 14 is elastically supported.

One end of each leaf spring 35 is fixedly attached to coupling body 13c while the other end of each leaf spring 35 is in close contact directly with inner ring 14b of tilt bearing 14 or to be in close contact with a front end of worm gear shaft 12 by being is bent to worm gear shaft 12 and each leaf spring 35 is arranged in plural at a predetermined angle in the circumferential direction.

In another exemplary embodiment of the present invention, the exemplary embodiment as shown in FIGS. 5 and 6 may be applied to the present exemplary embodiment. For instance, a stopper 15 may be fitted with and fixedly mounted on the outer periphery of driving shaft 11, a spring seat 13b may be formed on a lateral surface of coupling 13 opposed to stopper 15, and a coil spring 16 may be inserted between stopper 15 and spring seat 13b as an elastic body, thereby elastically supporting coupling 13 while elastically pushing coupling 13 toward worm gear shaft 12 with the lift springs 35 fixedly attached to coupling body 13c.

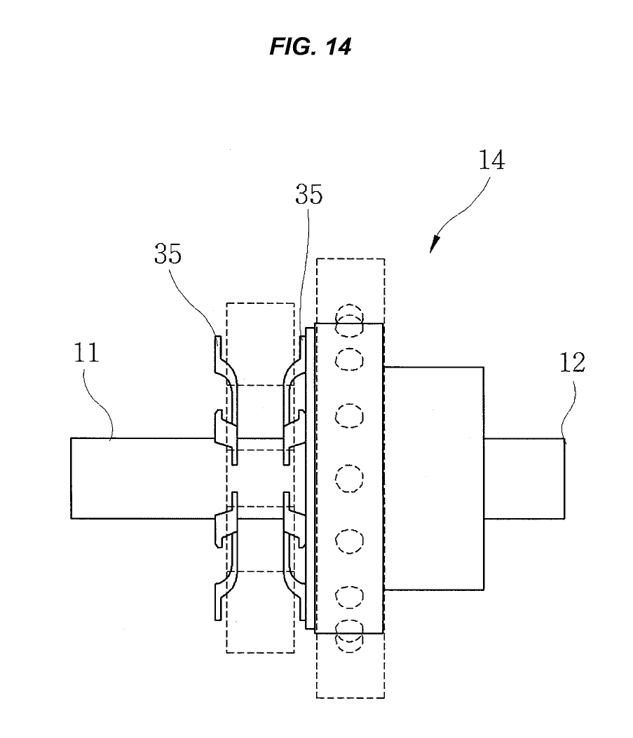

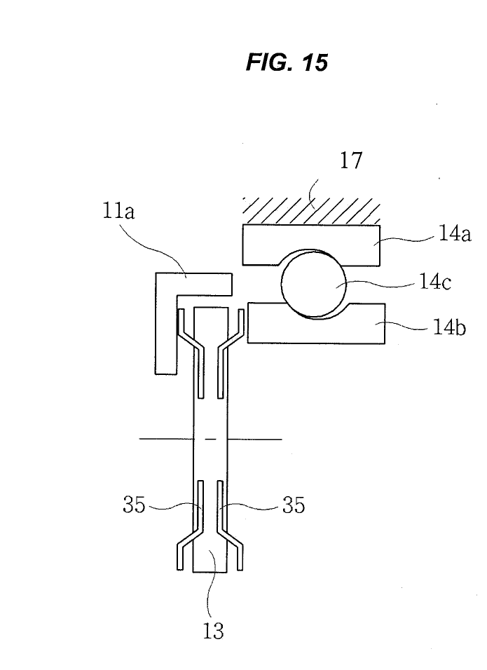

FIGS. 14 and 15 are a front view and a cross-sectional view of a major part of a motor driven power steering system with a noise reduction device illustrating a fifth exemplary embodiment of the invention. In the fifth exemplary embodiment, leaf springs 35 are attached onto one lateral surface of coupling body 13c opposed to the motor and the other lateral surface of coupling body 13c opposed to worm gear shaft 12, such that the damping and shock-absorbing effects are better than those in the fourth exemplary embodiment by the leaf springs 35, thereby improving the noise reduction effect.

That is, leaf spring 35 is also interposed between surfaces of power transmission member 11a connecting driving shaft 11 of the motor and coupling 13, which are opposed to each other.

Leaf springs 35 mounted on both lateral surfaces of coupling 13 are attached to be left-right symmetric on the basis of coupling 13.

In another exemplary embodiment of the present invention, the exemplary embodiment as shown in FIGS. 5 and 6 may be applied to the present exemplary embodiment. For instance, a stopper 15 may be fitted with and fixedly mounted on the outer periphery of driving shaft 11, a spring seat 13b may be formed on a lateral surface of coupling 13 opposed to stopper 15, and a coil spring 16 may be inserted between stopper 15 and spring seat 13b as an elastic body, thereby elastically supporting coupling 13 while elastically pushing coupling 13 toward worm gear shaft 12 with the lift springs 35 mounted on both surfaces of coupling 13.

By a noise reduction device of a motor driven power steering system according to various aspects of the present invention, movement of a worm gear shaft and a shock to a tilt bearing are properly absorbed by elastically supporting an inner ring of a tilt bearing that rotatably supports the worm gear shaft by means of a plurality of elastic projections projected from a coupling and an elastic body such as a spring that supports the coupling, and a damping function is implemented by providing the elastic body even to a connection portion between the coupling and a motor, whereby it is possible to improve an operation feel of a steering wheel and ride comfort by effectively reducing the operation noise of the tilt bearing in controlling the steering wheel.

For convenience in explanation and accurate definition in the appended claims, the terms “left” or “right”, “upper”, and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A noise reduction device of a motor driven power steering system, comprising:
a worm gear shaft, one end of which is connected with a tilt bearing that is coupled to a housing and rotatably supports the worm gear shaft;
a driving shaft connected to a motor;
a power transmission member integrally fitted with the driving shaft of the motor;
a coupling connected to one end of the driving shaft of the motor and integrally coupling the driving shaft of the motor to the worm gear shaft to be rotatable therebetween, wherein the coupling includes a coupling body; and
an elastic cushion member formed on one or both lateral surfaces of the coupling to buffer vibration and/or noise.

2. The noise reduction device as defined in claim 1, wherein the coupling includes a plurality of arms that project in a radial direction from outer periphery of the coupling body with a predetermined interval in a circumferential direction thereof.

3. The noise reduction device as defined in claim 1, further comprising an elastic actuating member that is disposed between the motor and the coupling, and elastically actuating the coupling toward the worm gear shaft.

4. The noise reduction device as defined in claim 3, wherein the elastic actuating member is mounted on the driving shaft of the motor.

5. The noise reduction device as defined in claim 3, wherein the elastic actuating member includes:
a stopper fastened to a stationary member and slidably receiving the driving shaft of the motor;
a spring seat formed on the coupling; and
an elastic member interposed between the stopper and the spring seat to bias the spring seat toward the worm gear shaft.

6. The noise reduction device as defined in claim 5, wherein the elastic member is a coil spring.

7. The noise reduction device as defined in claim 1, wherein the elastic cushion member is interposed between the worm gear shaft and the coupling.

8. The noise reduction device as defined in claim 7, wherein the elastic cushion member elastically supports an inner ring of the tilt bearing or a front end of the worm gear shaft.

9. The noise reduction device as defined in claim 8, wherein the elastic cushion member includes a plurality of elastic projections formed on arms of the coupling, a plurality of arms being configured to project in a radial direction from outer periphery of the coupling body with a predetermined interval in a circumferential direction thereof.

10. The noise reduction device as defined in claim 8, wherein the elastic cushion member is a plate spring that is mounted on the coupling body and bent toward the worm gear shaft.

11. The noise reduction device as defined in claim 8, wherein the elastic cushion member is a plurality of leaf springs that are mounted on the coupling body, arranged with a predetermined interval in a circumferential direction thereof, and bent toward the worm gear shaft.

12. The noise reduction device as defined in claim 1, wherein the elastic cushion member facing the power transmission member elastically supports the power transmission member.

13. The noise reduction device as defined in claim 12, wherein the elastic cushion member includes a plurality of elastic projections formed on arms of the coupling, a plurality of arms being configured to project in a radial direction from outer periphery of the coupling body with a predetermined interval in a circumferential direction thereof.

14. The noise reduction device as defined in claim 12, wherein the elastic cushion member is a plate spring that is mounted on the coupling body and bent toward the power transmission member.

15. The noise reduction device as defined in claim 12, wherein the elastic cushion member is a plurality of leaf springs that are mounted on the coupling body, arranged with a predetermined interval in a circumferential direction thereof, and bent toward the power transmission member.

16. The noise reduction device as defined in claim 1, wherein elastic cushion members formed on both lateral surfaces of the coupling are arranged to be left-right symmetric on the basis of the coupling.

17. A passenger vehicle comprising the noise reduction device as defined in claim 1.
